(19) United States
(12) Patent Application Publication
(10) Pub. No.: US 2010/0284201 A1
(43) Pub. Date: Nov. 11, 2010

(54) Illuminator using non-uniform light sources

(75) Inventors: Ilkka A. Alasaarela, Oulu (FI); Jussi Soukkamaki, Oulu (FI); Teuvo K. Viljamaa, Oulu (FI); Juha Lipponen, Oulu (FI)

Correspondence Address: HARRINGTON & SMITH, 4 RESEARCH DRIVE, Suite 202, SHELTON, CT, 06484-6212, US

(73) Assignee: Upstream Engineering Oy

(21) Appl. No.: 12/800,122

(22) Filed: May 6, 2010

Related U.S. Application Data
(60) Provisional application No. 61/215,585, filed on May 6, 2009.

(51) Int. Cl. G02B 6/00

(52) U.S. Cl. 362/551

(57) ABSTRACT

An optical system comprises at least a source module comprising a non-uniform extended source (e.g., RGB-LED), an optical engine, and at least one of a lightpipe and a lenslet array arrangement. The optical engine is by example detailed at co-owned WO 2008/017718, and has a first toroidal ray guide and a second ray guide defining a common axis of revolution and having complementary imaging surfaces and pupils. For the case in which the system includes the lightpipe, such a lightpipe is disposed between the source module and the optical engine. For the case in which the system includes the lenslet array arrangement, the optical engine is disposed between the source module and the lenslet array arrangement. At least one ray guiding component, also detailed at WO 2008/017718, can be an alternative to the above optical engine. The lenslet array arrangement may include first and second lenslet arrays having corresponding lenslets.

### CROSS REFERENCE TO RELATED APPLICATION

This application claims priority under 35 USC 119(e) to U.S. Provisional Application Ser. No. 61/215,585, filed on May 6, 2009 and entitled “Illuminator Using Multiple Light Sources”, the contents of which are incorporated by reference herein in its entirety including Exhibit A attached thereto.

### TECHNICAL FIELD

The teachings herein relate generally to optical devices such as collimators, particularly those operating with a multi-chip and multi-colored light source such as an RGB-LED (red-green-blue light emitting diode) for example. These teachings are particularly advantageous for use in a color tunable LED spot light, or in a LED illuminated projectors.

### BACKGROUND

The development of the light emitting diode (LED) technology has increased the use of LED sources in a wide variety of applications. Examples of such new application areas are LED illuminated data-projectors, LED illuminated fiber optic projectors and LED illuminated spot lights. There is a continuous need for smaller and cheaper optical engines for data-projectors, which has generated the need of using so called RGB-LED sources, a multi-chip LED sources consisting typically a red, two green and a blue LED chips on the same circuit board, efficiently. In fiber optic projectors the use of RGB-LED sources would eliminate the need of rotating color wheels which are needed when a white light source is used. The use of these multi-chip LED sources is attractive in the field of LED spot lights, too, due to the fact that they can share the same collection optics which would enable non-colored exit surface and shadows without colored edges. Typically LED based spot-lights have separate collection optics for each chip of different color, which means that without large secondary optics, a viewer can see outputs of different colors and shadows have colored edges.

There are various methods proposed for collecting and collimating light from a multi-chip source in a uniform way, as depicted in FIGS. 1A-1D. One proposed solution is to use a tapered light-pipe with a relay lens shown in FIG. 1A, in which the tapered light pipe is used for collecting and collimating the light from a multi-chip source, and a relay lens(es) is used to image the lightpipe output forward. Weaknesses of this approach are among others the increased etendue due to beam coupling to the light-pipe input surface, inconsistency with encapsulated LED sources (i.e. LED sources where LED chips are inside a transparent dome for higher external efficiency), and long size needed for mixing purposes and relay lens conjugates.

Another solution is a (total-internal-reflection) TIR-collimator with a fly's eye lens array, shown in FIG. 1B. That configuration is shorter than the tapered lightpipe solution, and can be used with encapsulated chips as well. However, a severe drawback is the etendue increase, due to non-imaging operation of TIR-collimators with side-emitted rays.

Still another solution is to use a high-NA (numerical aperture) lens or lens pair and a fly's eye lens, shown in FIG. 1C. The solution is shorter than tapered lightpipe solution, but as with the lightpipe, the high-NA lens need to be positioned close to the chip, too, which prevents using encapsulated chips. Similarly as with the TIR-collimators, the poor imaging quality of the high-NA lenses with the side-emitted rays causes an etendue increase.

A classical solution is to use a conical reflector such as compound parabolic concentrator (CPC) with a fresnel lens, or a fly's eye lens array. This configuration is shown in FIG. 1D. The solution is large in size, and has the same etendue increase problem as with the previous approaches.

In the most demanding applications, such as in LED illuminated data-projectors and high-end LED spot-lights, there is clear need for better solutions which can collect substantially all light from a multi-chip source, and homogenize and collimate the light in a small space and preserving the etendue.

Co-owned U.S. patent application Ser. No. 11/891,362, with priority to Aug. 10, 2006 and entitled “Illuminator Method and Device”, (with related PCT application published on Feb. 14, 2008 as WO 2008/017718 and which is hereby incorporated by reference) describes a component, termed herein an “illuminator module” for brevity, which solves the problem of efficiently collecting and collimating the light from a source such as LED chips. The illuminator module is substantially imaging, providing collection and collimation in an etendue-preserving way and in a small space. However, due to imaging, it alone cannot homogenize the beam output from a multi-colored multi-chip source.

For example when using the illuminator module with a multi-chip source consisting a red, a green and a blue chip on the same circuit board, the resulting beam substantially consists of the image of the multi-chip source, which is not desired when uniform white beam is desired.

### SUMMARY

According to a first aspect of the invention there is provided an optical system comprising at least a source module, an optical engine, and at least one of a lightpipe and a lenslet array arrangement. The source module comprises a non-uniform extended source. The optical engine comprises a first toroidal ray guide defining an axis of revolution and having a toroidal entrance pupil adapted to image radiation originating from the source module that is incident on the entrance pupil, in which the first toroidal ray guide has a first imaging surface opposite the entrance pupil. The optical engine also includes a second ray guide also defining the axis of revolution and having a second imaging surface adjacent to the first imaging surface. For the case in which the system includes the lightpipe, such a lightpipe is disposed between the source module and the optical engine. For the case in which the system includes the lenslet array arrangement, the optical engine is disposed between the source module and the lenslet array arrangement.

In various exemplary but non-limiting embodiments of this first aspect or of the second aspect below, the non-uniform extended source comprise multiple wavelength light sources, the multiple wavelength light sources comprise at least one red, one green, and one blue light emitting diode, and/or the toroidal entrance pupil is adapted to image radiation incident on the entrance pupil at an angle between 40 and 140 degrees.

In particular exemplary but non-limiting embodiments of the first aspect above or the second aspect below which include the lenslet array arrangement, such an arrangement comprises a first lenslet array and a second lenslet array arranged such that light incoming to each lenslet of the first lenslet array is directed to a corresponding lenslet in the second lenslet array. In a more particular embodiment the first and second lenslet arrays are spaced from one another by a distance L that is close to the focal length of the lenslets multiplied by the index of refraction of an optical material disposed between the first and second lenslet arrays. In a still further particular embodiment at least one of the first and second lenslet arrays is moveable relative to the other of the first and second lenslet arrays in a direction of an optical axis of the lenslets. And in a yet further embodiment the optical system further comprising a fly's eye lens arrangement disposed between the optical engine and the first lenslet array. Lenslets of the first and second arrays may be oriented commonly in at least five different sections across the first and second arrays.

According to a second aspect of the invention there is provided an optical system comprising at least a source module, at least one ray guiding component that is substantially cylindrically symmetrical about an axis of revolution, and at least one of a lightpipe and a lenslet array arrangement. The source module comprises a non-uniform extended source. For the case in which the system includes the lightpipe, such a lightpipe is disposed between the source module and the at least one ray guiding component. For the case in which the system includes the lenslet array arrangement, the at least one ray guiding component is disposed between the source module and the lenslet array arrangement. The at least one ray guiding component is arranged to substantially image at least a portion of the rays, which emanate from the source module towards an entrance pupil of the said at least one ray guiding component, to an image. The at least one ray guiding component is also arranged to substantially image the entrance pupil into an exit pupil of the at least one ray guiding component, such that each point on the entrance pupil is substantially imaged to a projection of the point substantially along the direction of the said axis of revolution on the exit pupil. The at least one ray guiding component is further arranged to have substantially all points of the entrance pupil at approximately a same distance from the source module. And the at least one ray guiding component is also arranged so that no path of any meridional ray imaged from the entrance pupil into the exit pupil crosses the axis of revolution between the entrance pupil and the exit pupil.

Further objects and advantages will become apparent from a consideration of the ensuing description and drawings.

### BRIEF DESCRIPTION OF THE DRAWINGS

FIGS. 1A-1D are sectional views of various prior art devices.

FIG. 2 is a schematic diagram of an optical system according to an exemplary embodiment of the invention.

FIGS. 3A-L illustrate characteristics of a beam at various sections of the optical system at FIG. 2.

FIGS. 4A-E illustrate various embodiments of a source module for the optical system of FIG. 2.

FIGS. 5A-B illustrate additional embodiments of a source module for the optical system of FIG. 2.

FIG. 6 is a perspective view of a filament with its mirror image adjacent to it as source for the optical system of FIG. 2.

FIG. 7 is a perspective view of an exemplary lightpipe for the optical system of FIG. 2.

FIGS. 8A-E are exemplary embodiments of a fly's eye integrator for the optical system of FIG. 2.

FIGS. 9-10 illustrate respectively a lenslet array and ray tracing through one lenslet of such an array.

FIGS. 11A-B illustrate five sectors due to different orientations of hexagonal lenslets per sector within a lenslet array, with resulting illumination at FIG. 12.

FIG. 13 shows a magnified view of surface deformations of a gaussianizer of the optical system of FIG. 2, and FIG. 14 shows a plan view of another embodiment of the gaussianizer.

FIG. 14 illustrates beam sections before and after passing through the gaussianizer, and FIG. 16 shows the profile of those beam sections.

FIGS. 17-18 are respective top and perspective views of a gaussianizer integrated with a lenslet array using pseudo-randomized lenslet surface shapes, which avoids the need for sections of lenslets as in FIGS. 11A-B.

FIG. 19 is one lenslet pair of FIGS. 17-18 in isolation.

FIG. 20 illustrates in plan view several exemplary embodiments of the lenslet arrays.

FIGS. 21-23 illustrate various other embodiments of an optical system different from that shown at FIG. 2.

FIG. 24 illustrates an embodiment of an optical system having a fly's eye integrator configured for zoom operation, and FIG. 25 illustrates schematically different positions of the lenslet arrays for different zooms.

FIGS. 26A-C illustrate different implementations of boundaries in a fly's eye integrator of the optical system to avoid cross talk between adjacent lenslets.

FIG. 27 is another embodiment of an optical system which employs a zoom fly's eye integrator similar to that of FIG. 24.

FIG. 28 is a perspective view of a different implementation of a gaussianizer, and

FIG. 29 shows sections of a beam therethrough to approximate a Gaussian barn profile.

FIG. 30 is sectional view similar to FIG. 2 of an embodiment that was tested and quantified via simulation, with testing results and ray traces shown at FIGS. 31, 32A-B and 33A-B.

FIG. 34 is a sectional view of an optical system similar to FIG. 2 but adapted with a lens arrangement to direct light into a fiber bundle.

FIG. 35 is an embodiment of an optical system similar to that shown at FIG. 2 for use as a LED spotlight.

FIG. 36 is an embodiment of the invention in which non-uniform beam is transformed to provide uniform illumination to a target.

FIGS. 37A-B are implementations of FIG. 36 for use in microscope applications.

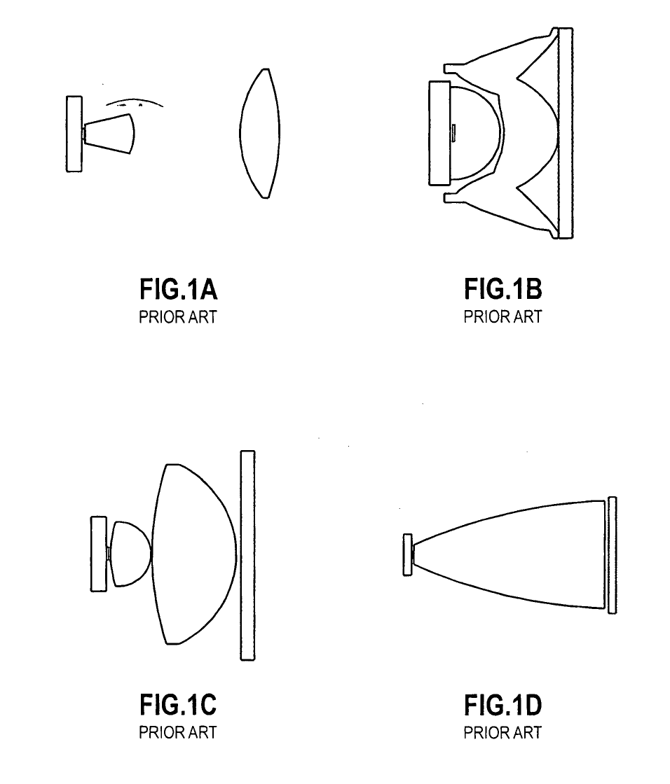

### DETAILED DESCRIPTION

### Advantages

Embodiments of this invention provide compact and efficient devices for collecting, collimating and homogenizing a light from a multi-chip LED source, and are particularly advantageous for LED-illuminated projectors and LED-illuminated spot lights.

One problem with RGB-LED sources is how to collect the light, mix the colors and shape the beam most efficiently and with high color uniformity, in a small space. Embodiments of this invention provide a solution for that need.

Embodiments of the invention provide an optical system which collects the light from a RGB-LED, (red-green-blue-white light-emitting-diode) RGBW-LED or some other multiple color/wavelength light source, mixes the colors and shapes the beam to a desired form. Certain embodiments provide one or more of the following advantages: high efficiency, high uniformity, high color uniformity, small size, mass-manufacturable with low cost, scalable with different sizes of LEDs, modular with variable beam shape and size (magnification), possibility for zoom solutions and possibility to use various color LEDs.

The requirements of the most demanding applications can be summarized as follows. An illumination system is needed which can accept light from a source with large spatial non-uniformities, either in brightness or color non-uniformities. The source may also have large non-uniformities in angular radiation pattern. The source is emitting to substantially a whole hemisphere. Substantially all light should be collected in a substantially etendue-preserving manner. The light should be delivered in a well-defined beam form which is uniform in both angular and spatial domains. In other words, both the near field output and the far field output of the illumination system should be uniform both in brightness and in color. The exemplary embodiments of the invention detailed herein provide systems fulfilling these requirements.

### Complete Solution

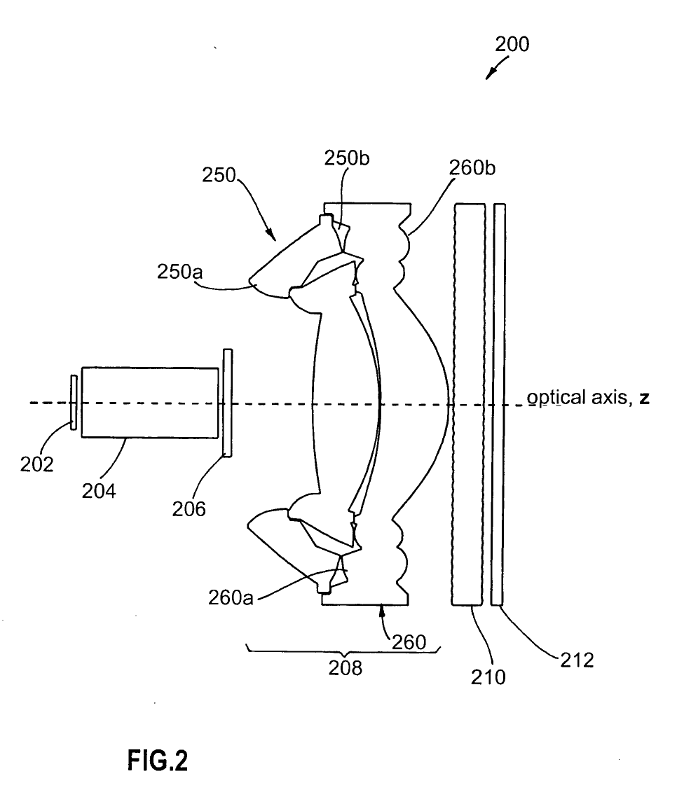

An exemplary embodiment of the invention is shown in FIG. 2. The illumination system 200 comprises:
A non-uniform extended source 202.
A lightpipe 204.
A diffuser 206.
An optical engine 208.
A fly's eye integrator 210.
A gaussianizer 212.

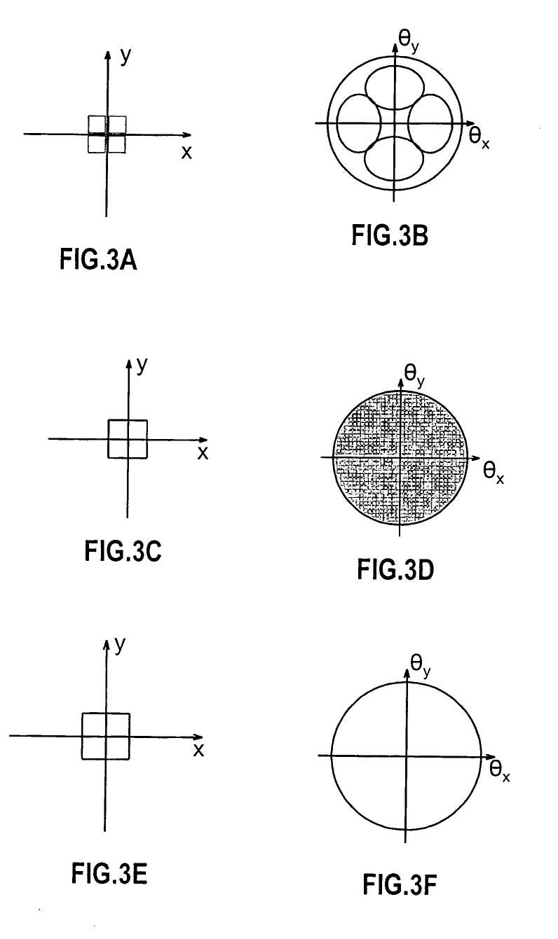

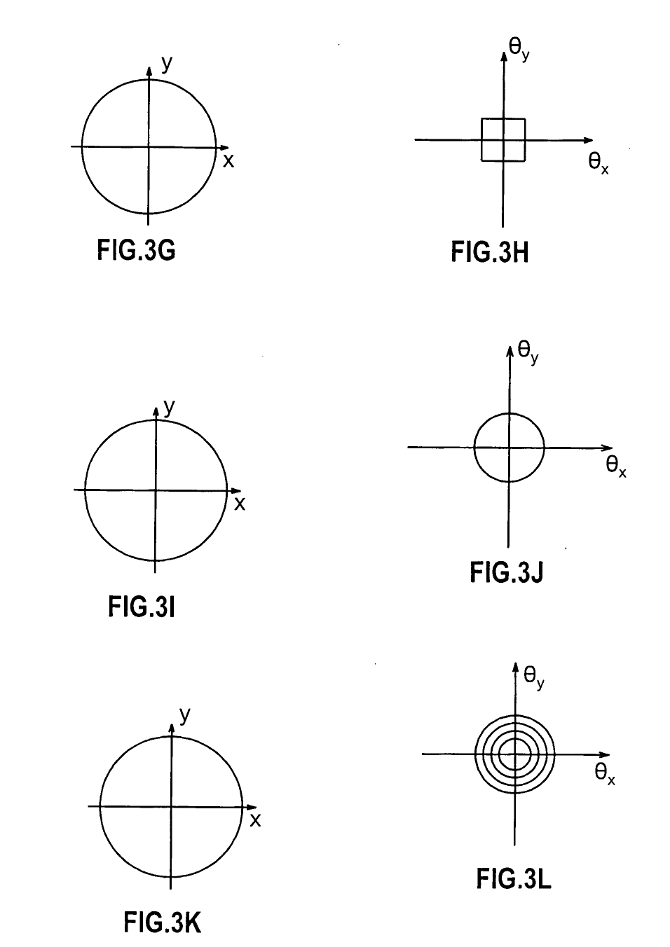

The source 202 is a non-uniform extended source which cannot be directly imaged to the illumination target due to uniformity requirements, for example a RGB-LED module consisting of one red, two green and one blue LED chip disposed on the same circuit board. The optical axis z of the system is shown through the center of the source module 202. The operation is explained together with FIG. 2 and FIG. 3A-3L. The source 202 is emitting light to a large opening angle, typically into the whole hemisphere.

Further detail of the optical engine 208, when embodied specifically as an illuminator module or illuminator component, is detailed at the above referenced co-owned patent application published as International Patent Publication WO 2008/017718. Briefly, such an exemplary optical engine comprises a first toroidal ray guide 250 defining an axis of revolution z and having a toroidal entrance pupil 250a adapted to image radiation originating from the source module 202 that is incident on the entrance pupil 250a. The first toroidal ray guide 250 also has a first imaging surface 250b opposite the entrance pupil 250a. The optical engine also includes a second ray guide 260 also defining the axis of revolution z and having a second imaging surface 260a adjacent to the first imaging surface. The toroidal entrance pupil 250a is adapted to image radiation that is incident on the entrance pupil 250a at an angle between 40 and 140 degrees.

In another embodiment as detailed at WO 2008/01778, the optical engine 208 may be embodied as at least one ray guiding component 250, 260 arranged to substantially image at least a portion of the rays, which emanate from the source module 202 towards an entrance pupil 250a of the at least one ray guiding component, to an image which lies at to right of FIG. 2. The at least one ray guiding component 250, 260 is also arranged to substantially image the entrance pupil 250a into an exit pupil 260b of the at least one ray guiding component, such that each point on the entrance pupil 250b is substantially imaged to a projection of the point substantially along the direction of the said axis of revolution z on the exit pupil 260b. The at least one ray guiding component 250, 260 is further arranged to have substantially all points of the entrance pupil 250a at approximately a same distance from the source module 202. And the at least one ray guiding component is also arranged so that no path of any meridional ray imaged from the entrance pupil 250a into the exit pupil 260b crosses the axis of revolution z between the entrance pupil 250a and the exit pupil 260b.

FIG. 3A and FIG. 3B show schematically the beam characteristics at the source 202. FIG. 3A presents the spatial distribution of light at the source 202, which is non-uniform consisting four areas with different colors and dark gaps there between. FIG. 3B presents the angular distribution of light from the source 202, which is non-uniform showing different intensities and different colors for different directions. θₓ and θ_{y} are the angles in xz and yz planes in respect to the optical axis z.

The lightpipe 204 is for example a rectangular pipe which is placed close to or above the source 202 such that majority of emitted light is coupled inside the lightpipe 204. The light encounters multiple reflections from the walls of the lightpipe and finally gets exited from the output face of the lightpipe 204. Due to the reflections, the spatial distribution at the lightpipe output is uniform, shown in FIG. 3C. The shape of the angular distribution, shown in FIG. 3D, however, is an array of spatial distributions of the beam at the lightpipe input surface, which is approximately the same location as the source 202.

After the lightpipe 204, the light hits the diffuser 206, which is preferably a high efficiency transmissive type such as holographic diffuser sheet for example. The diffuser 206 is close to the lightpipe output so it does not substantially alter the spatial distribution, shown in FIG. 3E, of light but homogenizes effectively the angular distribution, shown in FIG. 3F. The light is still emitted to a high opening angle, and the optical engine 208, which is termed an illuminator module when embodied as set forth at WO 2008/017718, is collecting the light and collimating it. The optical engine 208 substantially images the beam spatial distribution at the diffuser plate 206 to infinity. The spatial distribution at the optical engine output is a uniform circular disk shown in FIG. 3G and the angular distribution is rectangular as shown in FIG. 3H. The opening angle can be adjusted by adjusting the focal length of the optical engine 208. As we can see from the FIGS. 3G and 3H, the beam is uniform in both spatial and angular domain and the target specifications would now be fulfilled if the desired beam should have well defined rectangular form.

The fly's eye integrator FEI 210 and gaussianizer 212 are used to reshape the beam efficiently. After the optical engine 208, the beam passes the FEI 210, which in this case has hexagonal lenslets in sectorial arrangement, detailed further below. This arrangement provides a uniform and sharp circular white beam to the far field as shown in FIG. 3I and FIG. 3J. Gaussianizer 212 is a term introduced by these teachings for a component explained below. The gaussianizer 212 smoothes the beam angular output so that it is no longer a sharp disk but a white Gaussian spot. The corresponding spatial and angular distributions after the gaussianizer 212 are shown in FIG. 3K and FIG. 3L.

### Source Module

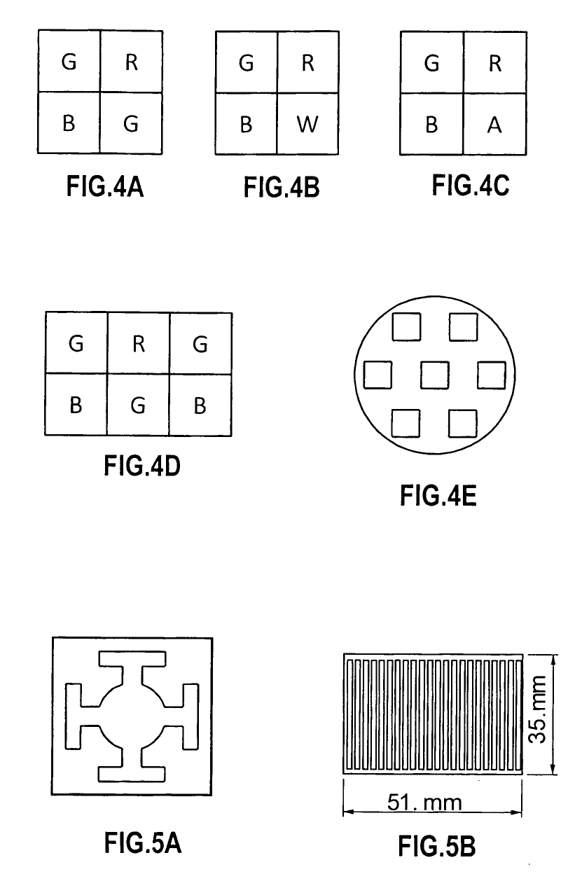

The non-uniform extended source 202 mentioned above can comprise different kinds of LED arrays. Typical multi-colored multi-chip LED modules are for example the ones shown in the FIG. 4A-4E examples. The letters correspond to colors: G=green, R=red, B=blue, W=white and A=amber. The array can include not only 4 but any number 2, 3, 5, 6, etc. of chips. Arrayed or single chips can be square as in FIG. 4A-4C, rectangular as in FIG. 4D or even circular such as for example in FIG. 4E, which shows seven led chips under phosphor encapsulation which has circular form. Exemplary embodiments of the invention can be used for producing a white-light beam, or a beam with some other color also. Exemplary embodiments of the invention can be used with sources which emit light at wavelengths outside the visible range, such as UV or IR regions for example.

The source (or source module) 202 can comprise a plurality of visible light sources (e.g., light source chips). In particular embodiments the source may exhibit any one or more of the following: at least two of the visible light sources emit substantially monochromatic light of a color that differs from one to another; the plurality of visible light sources are disposed adjacent to one another in an array; there is a white light source within the plurality of light sources; the source module comprises a plurality of visible light sources and at least one non-visible light source; the source module is arranged to emit all light from it to a hemisphere in a direction of the optical engine; the source module is encapsulated within a dome made from a refractive material having a refractive index greater than one; and each of the plurality of light sources is an LED. Any of these may be combined with any one or more of the others as to the source module 202.

Embodiments with One LED Chip

The source should not only be understand to necessarily consist of several LED chips, namely exemplary embodiments of the invention can as well be used for obtaining a uniform beam from one LED chip, such as when imaging does not provide a beam with good enough uniformity. For example an LED chip can output a beam having substantial non-uniformity due to an electrode structure which blocks emission from certain areas. An example of such a chip is shown in FIG. 5A. Besides the electrode structures blocking the light, the temperature gradients may cause non-uniformities between different areas of the chip. This can be a problem especially with large area (several mm²) chips. An example of such a chip is shown in FIG. 5B. Exemplary embodiments of the invention can be used to obtain a uniform beam from these chips as source module.

A typical problem with phosphor based white LEDs is that the color temperature of the emission varies both in spatial and angular domains of the emitted radiation. Exemplary embodiments of the invention solves problem, how to obtain beam with uniform color temperature across the beam. Similarly, exemplary embodiments of the present invention solves the corresponding color uniformity problem with other phosphor converted LEDs, such as highly efficient phosphor converted green LEDs emitting green light.

LEDs were used as exemplary light sources in the examples above, however the invention is not limited to be used with LEDs only but the invention can be implemented with other kind of light sources as well such as OLEDs, lasers, arc-lamps, UHP-lamps, light emitting plasma-lamps, etc. The common dominator for all these light sources is that the uniformity of the light source does not match with the uniformity requirements of the output beam. The source such as LED chips can be surrounded by air, or they can be encapsulated with a higher refractive index material. The LED chips can be encapsulated inside a silicone or epoxy dome for example. The source can emit light to whole sphere, to a hemisphere, or only part of it, for example.

The sources mentioned by example above are physical sources which emit light. The source 202 referred in this invention can as well be the output of another optical system. The source 202, as it is referred in these teachings, need not to be physical source emitting light, but it can be a volume in a space or in a material which transmit electromagnetic radiation. For example, the source 202 can be an aperture which is transmitting light originated from any system.

For example the source 202 can be an image or a virtual image of some physical light emitting source. The source 202 can be a mirror image of some physical light emitting source also.

For example, in a sensing system where a semi-transparent object under the measurement is illuminated from behind, embodiments of the invention can be used to collect transmitted and scattered light from the front side. In that case, a part of the illuminated object under measurement works as the source 202 for the system 200 detailed herein.

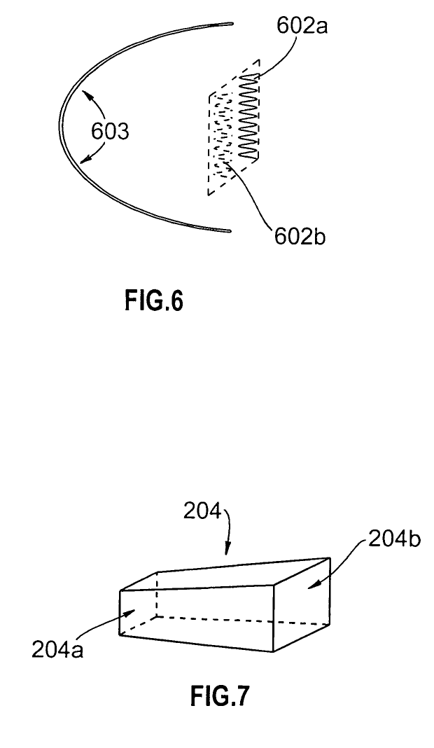

The source 202 can be a combination of physical sources with emit light and non-physical sources which only transmit or reflect radiation from a physical source. An example of that is an embodiment, where a physical source of light is imaged next to it as a mirror image. As an example FIG. 6 shows a case when backward emitted light from a tungsten filament 602a is reflected by using a conical mirror 603 to a mirror image 602b of the filament itself next to the filament 602a, which together can then be used as a source 202 for the optical system according to these teachings.

### Lightpipe

An exemplary lightpipe 204 is a rectangular block of optical material, such as BK7 for example, inside which the light is reflected by total-internal-reflection. Another class of lightpipes 204 are hollow lightpipes, which are composed of mirrorized walls and the beam propagates in air. The lightpipe 204 can be tapered, i.e. the cross-section can increase from the input face 204a to the output face 204b of the lightpipe 204 as shown in FIG. 7. Tapering provides preliminary collimation for the light beam, at the cost of homogenization efficiency. The lightpipe cross-section can be square, rectangular, circular, elliptical or any shape which provides the desired coupling efficiency from the source 202 to the lightpipe 204, and which provides the desired output shape for the illuminator module 208 as the illuminator module substantially images the spatial distribution of the lightpipe output. In order to not to increase etendue of the beam when coupling light from the source 202 to the lightpipe 204, the input aperture (or the cross-section) of the lightpipe 204 should be close to the same shape and size as the source 202. Etendue is better preserved when the lightpipe input aperture is closer to the source 202. The source 202 can also be just inside the lightpipe 204. If requirements for the etendue preservation are very strict, the shape of the output aperture of the lightpipe 204 is preferably close to the shape of the input aperture. When the input and output apertures are different size and/or shape, the walls of the lightpipe 204 are preferably smoothly transformed from the input to the output. The length of the lightpipe 204 may need to be adjusted according to the space available and the desired homogenization quality. Preferably the length of the lightpipe 204 should be at least two times the width of the lightpipe. By using a longer lightpipe the angular output of the lightpipe gets more uniform, too, which may enable certain embodiments to dispense with the diffuser 206 after the lightpipe 204.

For example, when using a (red-green-blue-white) RGBW-LED source with four 1×1 mm2 chips and total 2.1×2.1 mm2 emitting area, the lightpipe 204 could in an exemplary embodiment be a rectangular volume made of BK7-glass with dimensions of 2.3×2.3×8.0 mm.

### Diffuser

In one example embodiment the diffuser 208 is a block of optical material which appears to randomly change the direction of the incoming rays. The diffuser 208 is preferably a high efficiency transmissive type such as holographic diffuser sheet for example, which in a controlled manner diffuses rays substantially in an average forward direction only. In addition to holographic types, other implementations of the diffuser 208 includes a planar sheet of optical material which has small angular surface normal variations on one or both sides. When the variances of the surface normal direction is carefully designed such variances can produce a diffusing effect with a suitable ray diffusing distribution. Such diffusers 208 can be manufactured by micro-optical manufacturing methods for example.

### The Optical Engine

The optical engine 208 is configured to redirect light from an object (for example from a source 202, lightpipe 204 or diffuser 206) such that all light (which may or may not all be visible light, depending on the source) output from the optical engine 208 toward the fly's eye integrator 210 is substantially parallel, on average, to the optical axis z. The optical engine 208 may in certain exemplary embodiments be embodied as set forth at WO 2008/017718, referred to herein as an illuminator module. In various exemplary embodiments, also this light is output with its etendue substantially preserved, as compared to the light input to the optical engine 208 from the source module 202; and the optical engine 208 is arranged such that light output therefrom is within the opening angle of the fly's eye integrator 210.

### The Illuminator Module

The general operation of the illuminator module 208 is described in international patent application WO 2008/017718 A1, incorporated herein by reference. The illuminator module 208 shown in FIG. 2 comprises two or more injection moldable plastic or glass parts. The illuminator module 208 is designed in exemplary embodiments so that it substantially preserves the etendue of the beam and minimizes stray light. That makes it possible to use the FEI 210 for color homogenization purpose in an efficient manner. The typical half-opening angle of the output beam of the illuminator module 208 is between 1 and 30 degrees, and preferably between 2 and 20 degrees.

### Fly's Eye Integrator

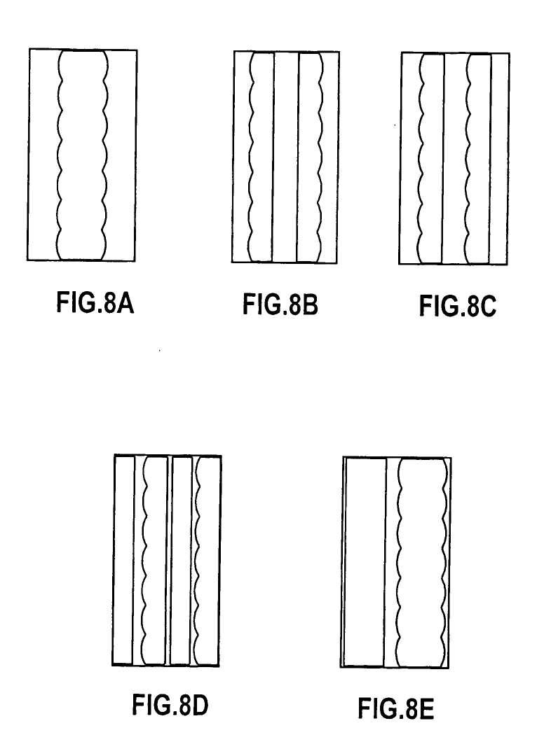

The general operation of the FEI 210 (which may also be referred to as a tandem lens array homogenizer) is described in “Homogeneous LED-illumination using micro lens arrays”, by Peter Schreiber, Serge Kudaev, Peter Dannberg, and Uwe D. Zeitner, Proc. SPIE 5942, 59420K (2005). The FEI 210 may be embodied in various ways as shown in FIGS. 8A-8E. The FEI 210 can be one unitary component, with lenslet arrays on both sides of it as shown in FIG. 8A. This is a cost effective and compact solution. Another implementation is to use two separate plates, which have lenslet arrays on one side of the plate, as shown in FIG. 8B-8C. It is possible to result in the same optical function by using four linear lens array surfaces (i.e. lenticular lens arrays), a pair of array surfaces in both x and y directions, as shown variously in FIG. 8D-8E.

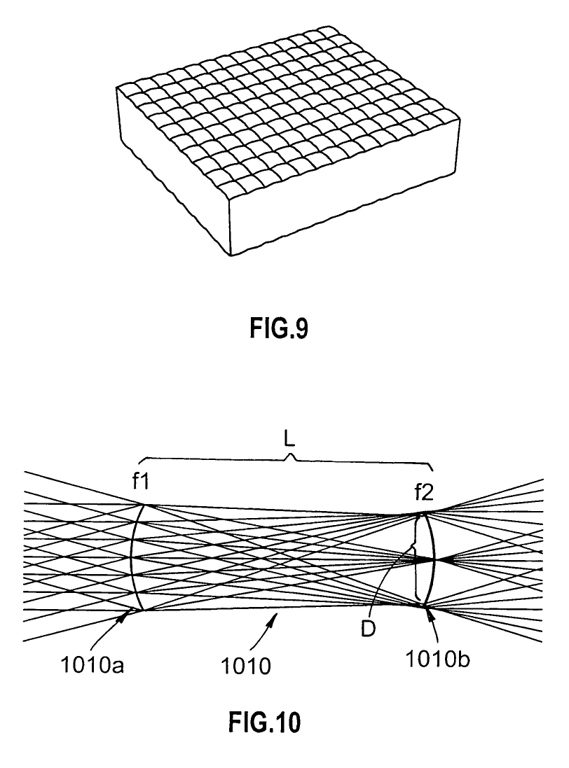

FIG. 9 shows a fly's eye integrator (FED, which comprises two lenslet arrays, separated by the focal length of the lenslets. The lenslets should be arranged in such a manner that each lenslet in the first array directs the incoming light onto one corresponding lenslet in the second array, and each lenslet in the second array substantially images the previous lenslet to infinity. FIG. 10 shows a single lenslet 1010 of a fly's eye integrator 210 with rays to show the function. Approximately f1=f2 and L=f1*n, where n=index of refraction of the material between the lens surfaces 1010a, 1010b, and f1 and f2 are the focal lengths of the lenslets. Here, approximately means within about 20% of equality.

### Sectorial Division of the Fly's Eye Integrator

Because circles cannot fully cover an area, if circular angular distribution is desired, the first lenslet array of the FEI 1010 needs to block light between the circular lenslets. Such blocking of light is typically done by using metal coating, e.g. an aluminum coating, between such circular lenslets. Naturally a part of the light is lost between those circular apertures. In exemplary embodiments of this invention a rectangular or preferably a hexagonal lenslet arrangement is used, which is a more efficient way for obtaining a circular beam by using a FEI arrangement 210. Particularly the hexagonal lenslets divide the FEI 210 into different areas with different array orientations.

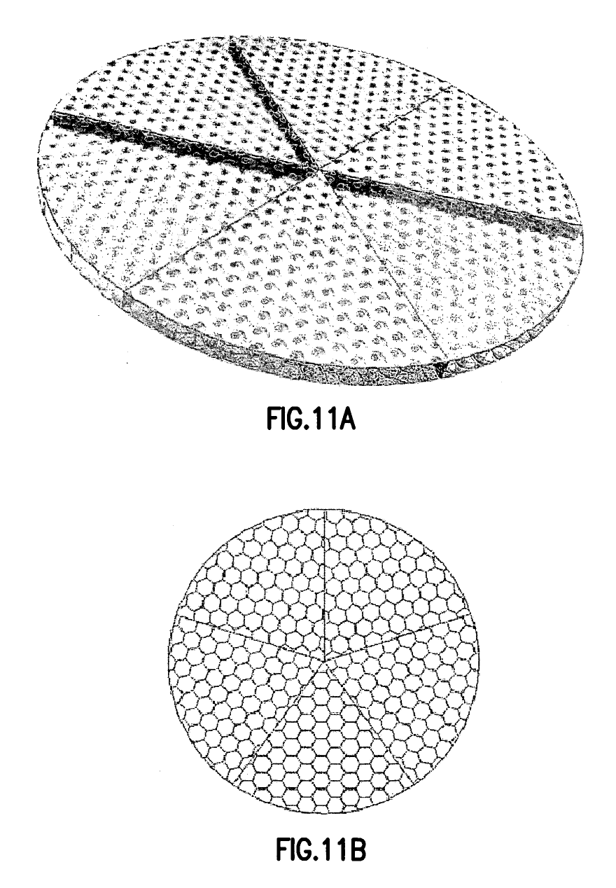

An exemplary embodiment of such an FEI 210 is shown in FIG. 11A in perspective view and in FIG. 11B in top view. The full integrator 210 of this specific embodiment shown at FIG. 11A-B consists of five sectors so that the total output beam is the sum of five hexagonal beams with a 10-degree angle difference between each beam. The sum resembles a 30-sided regular polygon, which is quite close to a circular beam. Closer approximations can be obtained by dividing the area into more sub areas with different orientations. This makes it possible to form a circular beam with high efficiency. When using circular lenslets, efficiency of the system is degraded because the lenslet circles cannot be packed next to each other to result in a 100% fill factor, which for example hexagonal lenslets can achieve.

FIG. 12 shows the hexagonal illumination from one of the sub-areas of FIG. 11A-B and the circular illumination which is the sum of the beam from all sub-areas of FIGS. 11A-B.

The same concept may be implemented with different array arrangements, for example with rectangular or triangular arrays. With suitable sub-area division, they will provide more or less smoothed circular beam angular distribution in the output beam.

### Gaussianizer

In an exemplary embodiment the gaussianizer component 212 is a sheet made of optical material, which is placed after the FEI 210. At least one surface of the sheet has micro- or millimeter scale surface deformations so that the transmitted beam is smoothed. For example a plastic optical sheet with cylindrically symmetric wave-like profile on one side of the sheet (inner side for example so that the outer side would be planar and so the sheet can work as a protecting window of the whole module).

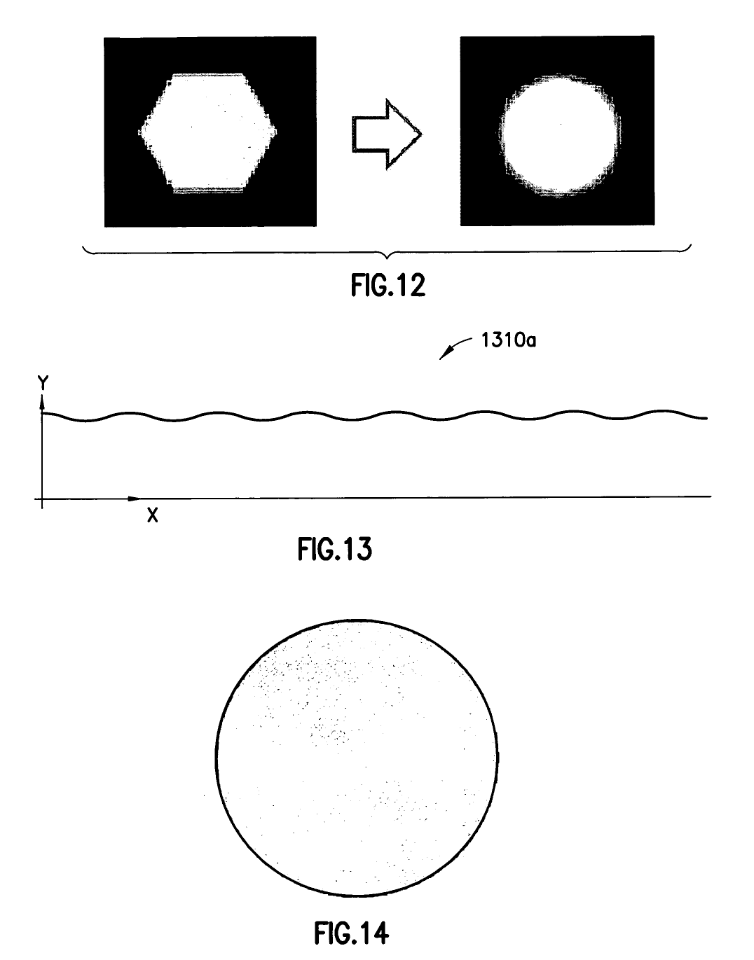

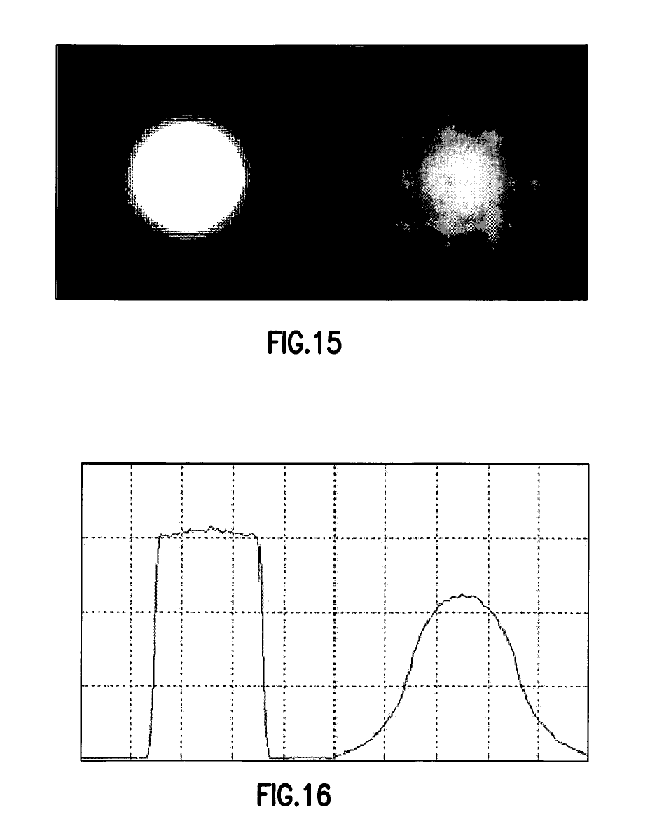

An exemplary sinusoidal profile is shown in FIG. 13, in which the optical axis of the system is parallel to the y axis. The micro or millimeter scale deformations are shown as 1310a. A top view of an exemplary gaussianizer 212 is shown in FIG. 14 with deformations shown as concentric circles. FIG. 15 shows the angular distribution of the beam before and after the gaussianizer 212. FIG. 16 shows the middle profiles of FIG. 15.

In an exemplary embodiment of the invention, the gaussianizer 212 may be replaced by a diffuser plate 206 such as that described above. In that case the standard deviation of the angular spread distribution of the diffuser in the position of the gaussianizer 212 needs to be about the same order of magnitude as the half-angular width of the beam before that same diffuser. The convolution of the angular spread distribution and the beam angular output represents the resulting gaussian angular distribution of the output beam.

The gaussianizer 212 can be integrated with the FEI 210 in certain exemplary embodiments. In one example this is accomplished by introducing a small scale ripple to the surface of each lenslet of the second lenslet surface 1010b of the FEI 210. The wavelength of the ripple needs to be clearly smaller than the width D of the lenslet. The ripple profile normal angular distribution in an exemplary embodiment is designed such that a suitable smoothing function is obtained. A wave-like ripple can be manufactured for example when a molding tool for the FEI 210 is manufactured by diamond turning. However, when the molding tool for the FEI 210 is manufactured by lithographic methods, several other forms of surface deformations become available, too. In that case the surface deformation need not to be cylindrically symmetric about the lenslet axis because the deformation can be directly etched to the surface form during the injection mold tool manufacturing process for example. In the case that the gaussianizer 212 is integrated with the FEI 210, the hexagonal lenslets can be used to generate a cylindrically symmetric beam without the abovementioned sectorial division due to the above smoothing function in the combined gaussianizer/FEI.

In an embodiment of the invention, a diffuser is integrated with the second lenslet surface 1010b of the FEI or with a surface that is optically close to the second lenslet surface, such that the angular distribution of the FEI 210 is smoothed.

### Randomized FEI

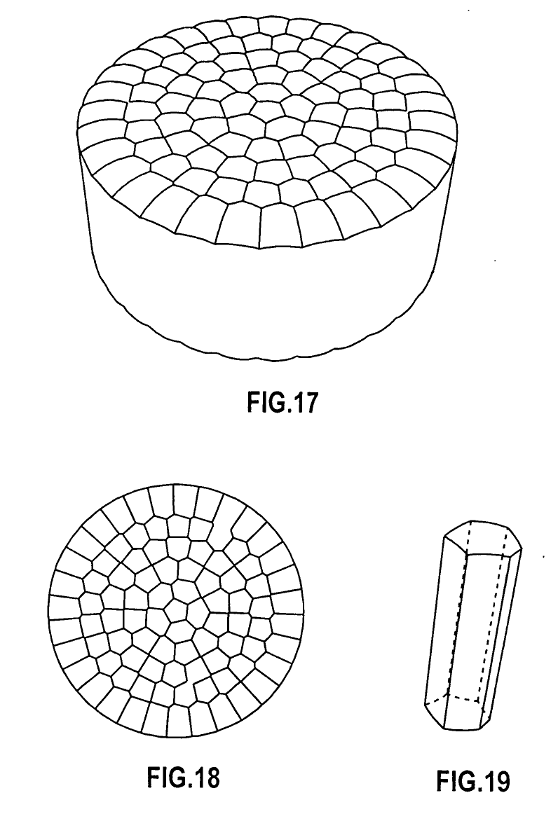

Another exemplary technique for integrating the operative function of the gaussianizer 212 with the FEI 210 is shown in perspective view in FIG. 17. A top view of the same is shown in FIG. 18, showing the lenslet arrangement. The lenslets are not arranged in an orderly manner, such as in rectangular or hexagonal array form, but in a controlled random way. As the outer shape and size of the lenslets varies in a controlled way, the final beam is the sum of possibly non-uniform polygons with different shapes and sizes. That arrangement provides a smoothed, Gaussian beam form. Each lenslet consisting of the first 1010a and the second 1010b lens surfaces is still designed as explained above. The lenslet arrangement is the same in both the first and the second surfaces. FIG. 19 shows in isolation a lenslet pair from the component shown in FIG. 18.

### Modularity

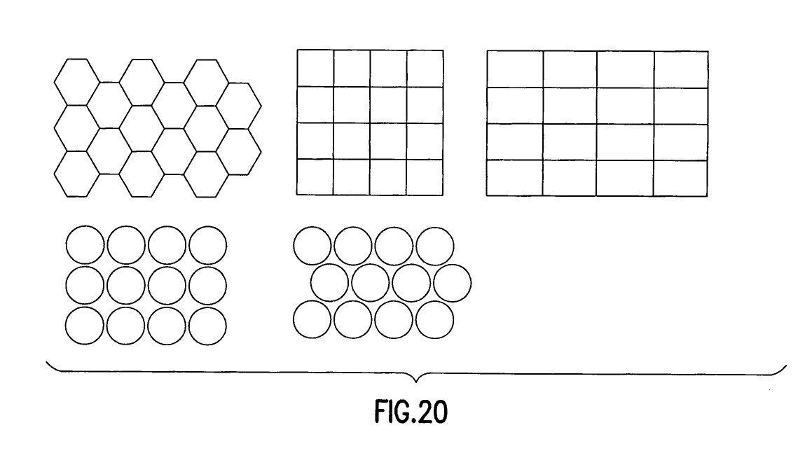

An exemplary embodiment of the invention using an FEI 210 is modular so that by using the same source 202 and the same optical engine 208 the beam shape and size can be varied by changing the FEI 210 and/or the gaussianizer 212. The lenslets can have the form of square, rectangle, hexagon, circle, triangle, ellipse or some other form, depending on the shape of the desired illumination and on the shape of the light coming from the source 202. The lenslets can be organized in different ways, for example rectangular arrays and hexagonal arrays of adjacent lenslets. FIG. 20 illustrates a few of these lenslet configurations from the perspective of the lenslet optical axes. The opening angle of the beam can be adjusted as well. In order to achieve good color uniformity the full output beam from the optical engine 208 should be inside the opening angle of the FEI 210.

Embodiment without FEI or Gaussianizer

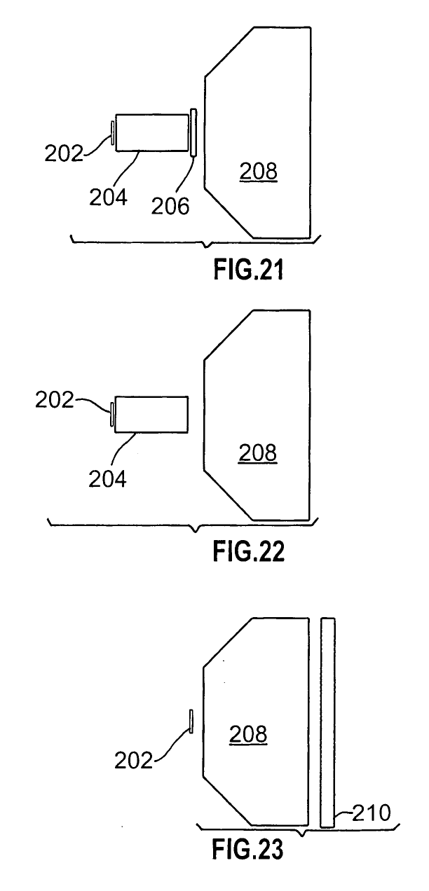

As said above, in some cases the requirements for the illumination system can be fulfilled without the FEI 210 and also without the gaussianizer 212. Such an embodiment is illustrated at FIG. 21 and comprises a non-uniform extended source 202, a lightpipe 204, a diffuser 206, and an optical engine 208.

This configuration is particularly useful when modularity provided by the FEI 210 is not needed, and the reshaping of the beam is not needed after the optical engine 208. There is modularity in this embodiment, too. The shape of the beam angular distribution can be changed by changing the lightpipe 204 so that the shape the output aperture (cross-section) of the lightpipe 204 matches with the desired beam form. If some loss of light is allowed, apertures can be used to shape the lightpipe output without need of changing the whole lightpipe 204. In one exemplary configuration, the diffuser 206 is located close to the focus of the optical engine 208. When the optical engine 208 is shifted so that the diffuser 206 becomes out-of-focus, the beam is smoothed, and a gaussian beam can be obtained.

Embodiment without Diffuser, FEI or Gaussianizer

When a source 202 is used which has only substantial spatial non-uniformities but not remarkable non-uniformities in the angular domain, or on the other hand if the requirements for the illumination system allow non-uniformities in spatial distribution of the illumination system as long as the angular distribution is uniform, a diffuser 206 is not necessarily needed. Such an embodiment comprising a non-uniform extended source 202, a lightpipe 204 and an optical engine 208 is shown in FIG. 22. An additional FEI (not shown) can optionally be used for reshaping the beam after the optical engine 208.

This embodiment is particularly suitable for the use in RGB-LED-illuminated data-projectors, because in those the spatial distribution of the illumination system is imaged to the projection lens pupil where uniformity and color uniformity are not an issue. However, those have very strict requirements for angular distribution uniformity because that is what becomes visible at the viewing screen. The lightpipe 204 homogenizes efficiently the angular distribution of the output of the optical engine 208.

Embodiment without Lightpipe, Diffuser, FEI or Gaussianizer

Another exemplary embodiment of the invention which can be used when the homogenization in the source's angular domain is not needed is presented in FIG. 23. This embodiment is particularly good in the respect that it allows the use of encapsulated LEDs with domes. The system comprises a non-uniform extended source 202, an optical engine 208 a fly's eye integrator 210 and an optional gaussianizer (not shown) if extra smoothing is desired. This embodiment has the advantage of modularity due to use of the FEI 210. The system is particularly beneficial as an illumination system in fiber optic projectors using a RGB light source, or using an array of white LEDs as a source for example. This embodiment is an excellent illuminator for data-projectors using RGB-LED as a source 202 or other non-uniform source 202, and provides very high efficiency due to the substantial etendue-preservation property of these and the other exemplary embodiments of the invention.

The configuration described with FIG. 22 together with the additional FEI 210 is particularly suitable for spot lights using RGB-LED sources 202 and when relatively high output half-angles are desired, for example half-angles more than 15 degrees. In those angles, the FEI 210 alone cannot necessarily achieve very strict color uniformity requirements. Pre-mixing at the lightpipe 204 between the source 202 and the optical engine 208 nicely resolves that problem. The maximum achievable half-angles of the FEI 210 can also be increased by using materials with a higher refractive index.

An embodiment of the current invention comprises a non-uniform extended source 202, a diffuser 206, an optical engine 208 and optionally an additional FEI 210. The diffuser 206 can be offset from the focus point of the optical engine 208, which provides smoothing of the beam angular output after the optical engine 208. A gaussianizer 212 can be added after the FEI 210 if extra smoothing is desired.

### Zoom Operation

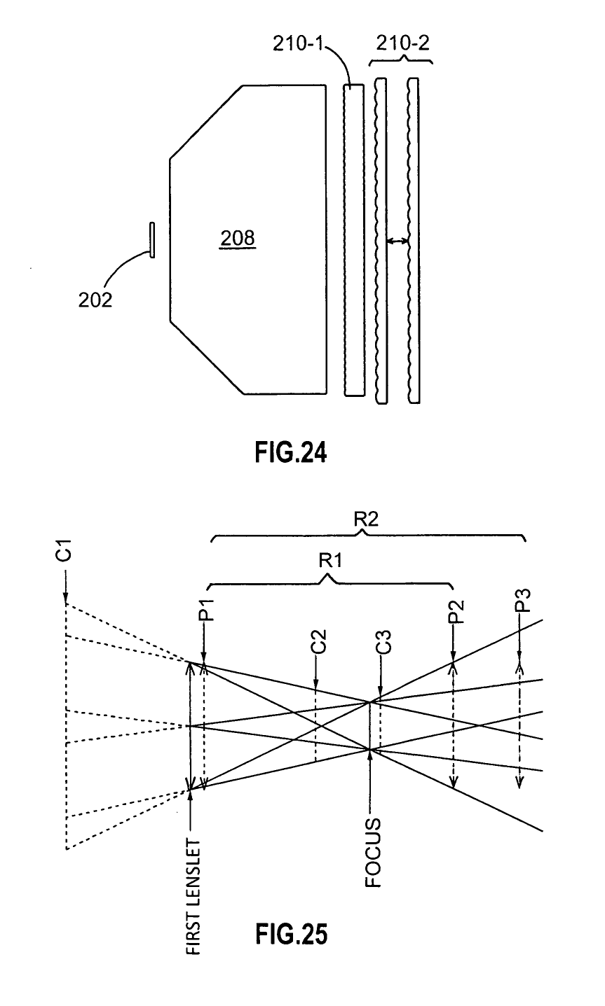

Some exemplary embodiments of the invention provide an adjustable beam angular output, i.e. a zoom operation, which is very useful for example in spot light applications. Such an embodiment is shown at FIG. 24. This embodiment resembles the one shown in FIG. 23 in that it includes a source 202, optical engine 208 and FEI 210-1, but FIG. 24 additionally includes a further FEI 210-2 (termed herein a zoom-FEI). The zoom-FEI 210-2 is comprised of two parts, whose mutual distance is adjustable either adjusting the position of the first or the second lenslet, or both, as indicated with the arrow in FIG. 24. When the distance is adjusted, the angular output of the beam becomes larger and smaller.

The operation of the zoom-FEI 210-2 can be understood by concentrating to the operation of one lenslet pair as shown in FIG. 25. The first lenslet creates an image of the angular distribution of the input beam at the focal distance from it. The zoom-FEI 210-2 is designed so that the acceptance angle of the FEI is larger than the opening angle of the input beam. Because of that, the spatial distribution of the beam converges from the first lenslet and in is smallest on the focus and expands after the focus. In a typical FEI 210 the second lenslet is located close to the focus and images the first lenslet to infinity. In the zoom-FEI 210-2 the second lenslet distance is adjustable. The second lenslet position can be adjusted in respect to the first lenslet in a range denoted as R1, the range being defined as the region where the second lenslet can substantially capture the full beam. If a small amount of cross-talk is allowed between the neighbor lenslets, the range can be even larger, as denoted by example with R2. A portion of the beam is not picked up by the second lenslet and is causing cross-talk. When the second lenslet is in its nearest position P1 to the first lenslet, it images a plane marked with C1 to infinity. The beam at plane C1 is a virtual beam cross-section marked with dotted lines from the first lenslet. The angular distribution of the zoom-FEI 210-2 is largest and somewhat smoothened. When the second lenslet is in its furthest position, P2 or P3, it images the corresponding planes C2 or C3 to the infinity. For R1 range, the angular distribution of the zoom-FEI is smallest, and for R2 it has passed the smallest form (which happens when the focus is imaged) and is a bit larger again.

By selecting the focal length of the second lenslet, it is possible to adjust the needed movement range of the second lenslet and the corresponding angular outputs. So, the focal lengths of the lenslets are not necessarily substantially equal with the zoom-FEI 210-2 as they typically are with normal FEIs 210.

When the opening angle of the output beam is changed with the distance between the lenslets, the shape of the beam is changed, too. The shape of the output is the same as the beam spatial distribution at the plane which is on the focal plane of the second lenslet. Therefore when the focal plane is near the first lenslet, the output beam is a uniform beam whose shape is the same as the shape of the lenslet. When the focal plane is near the focus of the first lenslet, the output is a smoothed spot. That can be used to form a Gaussian beam also.

In an exemplary embodiment of a zoom-FEI 201-2, the focal lengths of the lenslets are substantially equal, and the maximum optical distance between the lenslets is approximately the sum of the focal lengths of the lenslets.

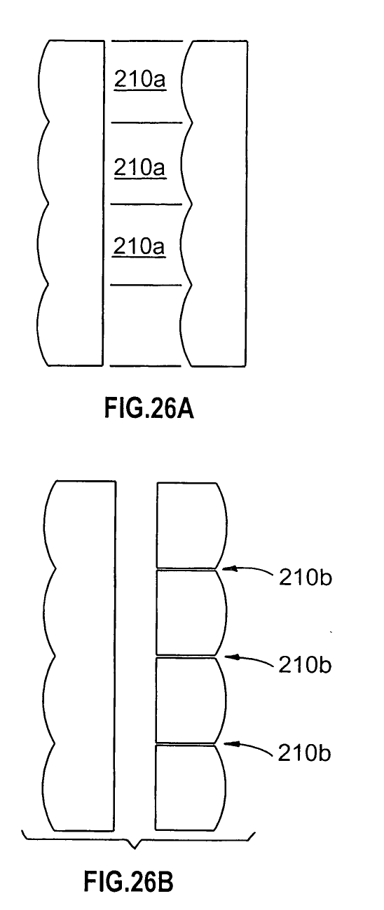

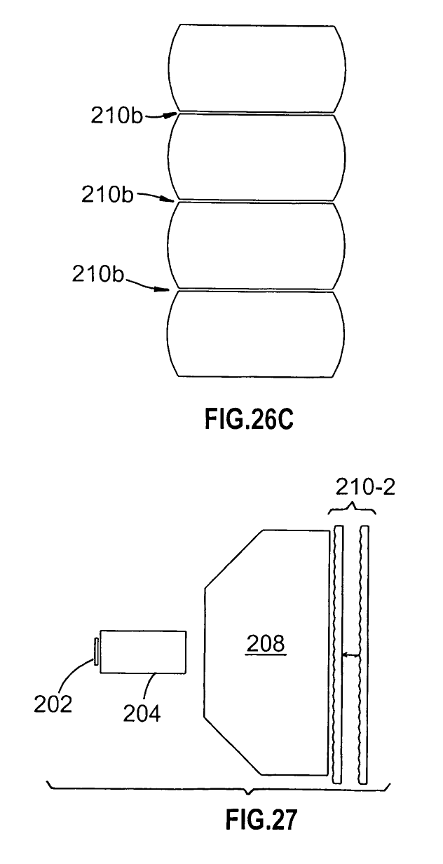

One possibility to avoid cross-talk between the lenslets is to use boundaries between the lenslets at least near the second lenslet. The boundary can be absorbing, reflecting or scattering, such as a shell 210a made of aluminium for example, shown in FIG. 26A, or the boundary can be based on total-internal-reflection which can be obtained by using a small air gap 210b between the neighbour lenslets, shown in FIGS. 26B and 26C.

The abovementioned concepts for FEI sub-areas with different orientations, the use of a gaussianizer 212 or diffuser 206 disposed after or integrated with the FEI 210, or the randomized FEI arrangement can be used with the zoom-FEI 210-2 also.

Another embodiment with a zoom operation is shown in FIG. 27 in which there is a source 202, lightpipe 204, optical engine 208 and zoom FEI 210-2. The embodiment resembles the one shown in FIG. 22, but with the zoom-FEI 210-2 added in place of the standard/non-zoom 210 implementation. The operation of the zoom function is similar as with the configuration in FIG. 24.

If no substantial homogenization is needed, a system with a zoom can comprise a source 202, an optical engine 208, and the zoom-FEI 210-2, possibly combined with the gaussianizer 212 or diffuser 206 for adding a bit more homogenization.

### Crossed Lenslet Array

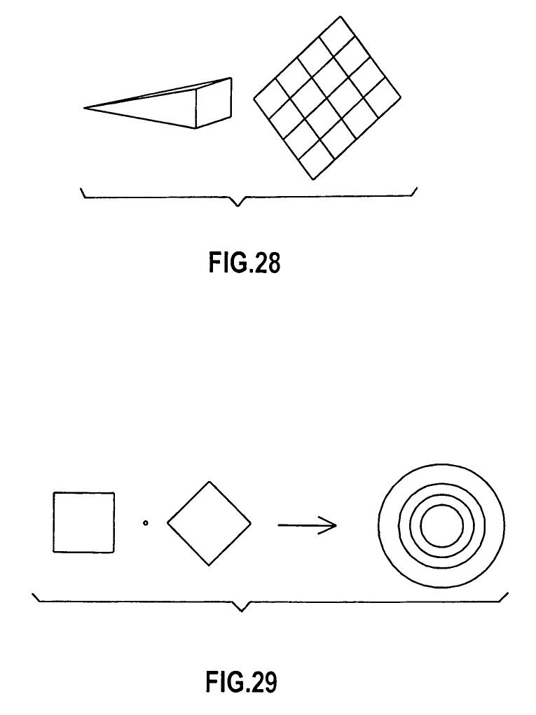

An alternative embodiment of the above-mentioned gaussianizer 212 which can be used when the angular output of the optical engine 208 or the FEI 210 following it is substantially square, is comprised of one square lenslet array as shown in FIG. 28 which is oriented diagonally with the square angular output of the beam. When the pitch, focal length and the distance of the array from the optical engine 208 or from the FEI 210 is designed to be suitable, the resulting beam is substantially a convolution of two square beams oriented diagonally to each other, as shown in FIG. 29. That results a smoothed octagon, which is Gaussian enough for many purposes.

### Simulation Example

The following simulation was done by using Zemax optical design software (by Zemax Development Corp., of Bellevue, Wash., USA). The illuminator module is made of two plastic parts (COC). The FEI, made of COC too, has hexagonal shape and 11 deg maximum full beam angle. The source is a 2.1 mm×2.1 mm square shaped LED array consisting one red, two green ad one blue 1 mm×1 mm LED chips. The amount of rays used in the simulations was five million rays per color.

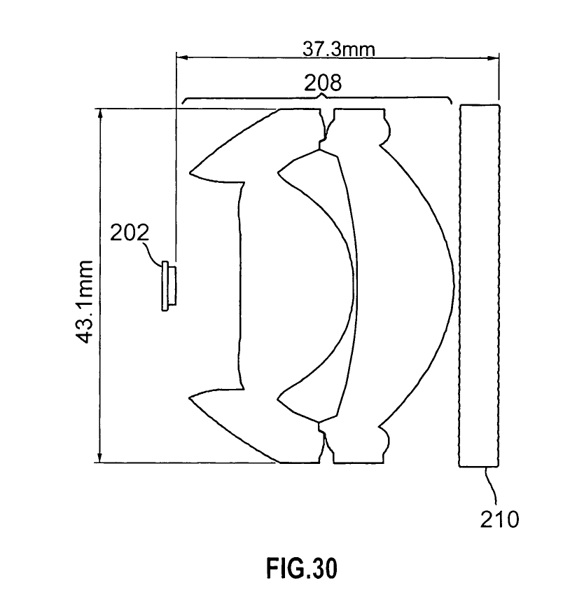

FIG. 30 shows the optical layout of the tested embodiment. FIG. 31 summarizes the properties of the FEI. FIG. 32A shows the ray tracing results from the LED module through the illuminator component/optical engine and the FEI. As can be seen, substantially all light is collected, the etendue is substantially preserved, stray light level is minimized and color uniformity is excellent. The noise which is apparent in the center profiles shown in FIG. 32B is coming from the source model measurement, so it is not a true property of the optical layout.

FIG. 33A and FIG. 33B show the simulation results after a small scale ripple is added to the second surface of the FEI. In other words, when the gaussianizer is integrated with the FEI. Each lenslet of the second surface of the FEI has small wave-like ripple cylindrically symmetric about the lenslet axis.

In accordance with an exemplary embodiment of the invention there is provided an apparatus that comprises a source module 202, a fly's eye integrator 210, and an optical engine 208 disposed between the source module 202 and the fly's eye integrator 210. These are arranged along an optical axis z, which one skilled in the art will recognize need not be a straight line as was shown above but may be skewed according to optical characteristics in the fabrication of the above components or by adding reflective and other additional optical components.

### Fiber Projector

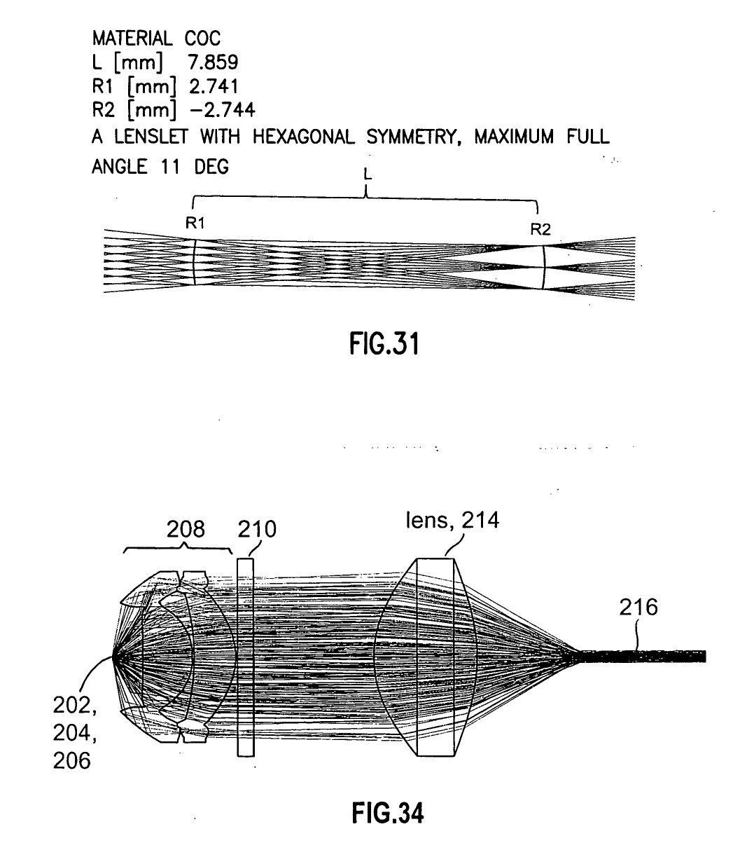

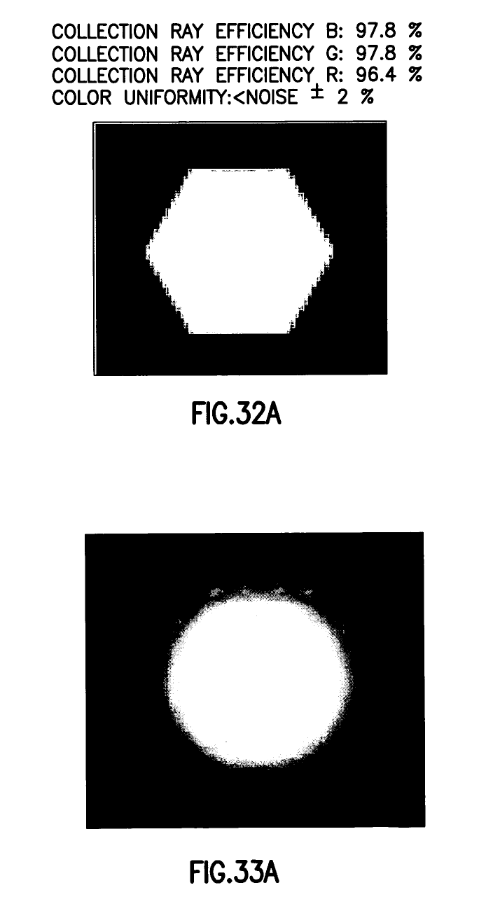

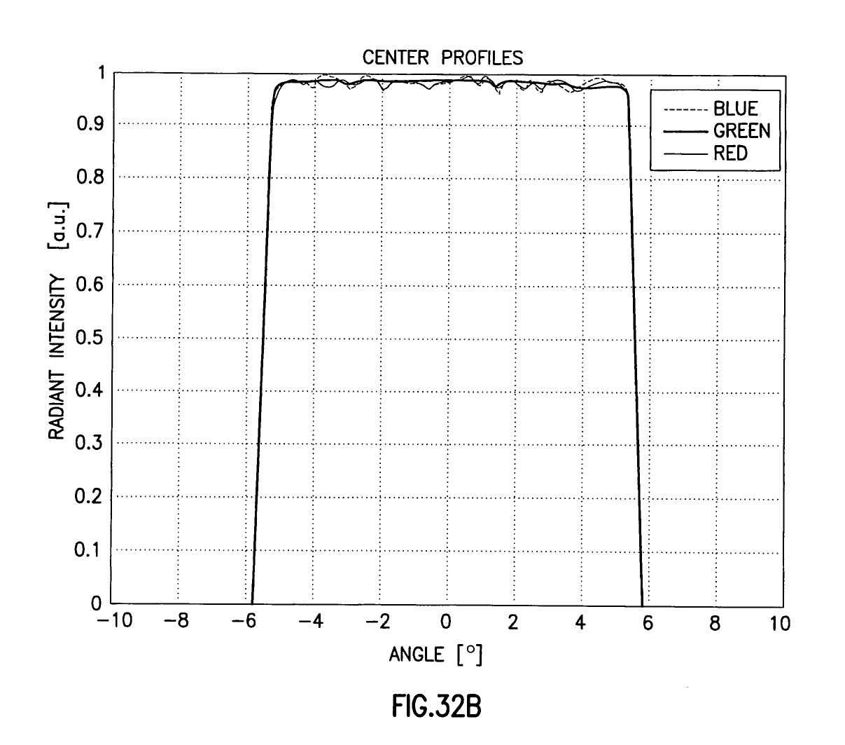

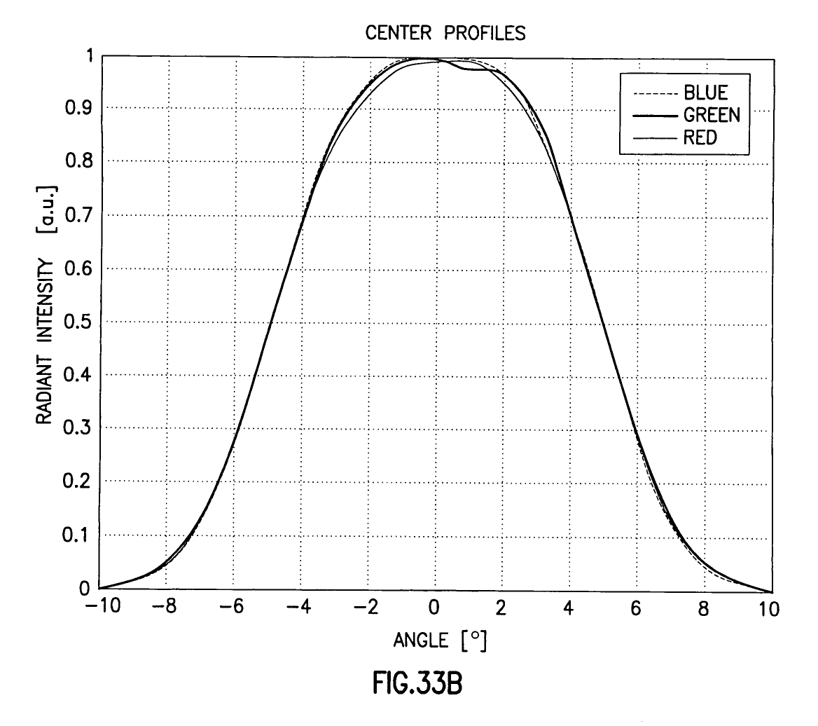

One exemplary embodiment of the invention uses the described beam collection and homogenization system as a part of a fiber projector for collecting and coupling the light into the optical fiber(s). Fiber projectors are used in special and decorative illumination and measurement applications. Fiber projectors have a problem in how to efficiently couple as much light as possible to a fiber, or typically to a fiber bundle. In addition to that, in many applications it is important that every fiber is filled with the same amount of light. As it was described above, exemplary embodiments of the invention solves these problems. In many applications there is need of color modulation which typically is obtained by using a white light source such as a halogen bulb or a white LED and then using a rotating color filter wheel between the source and the fiber bundle for obtaining light with different colors. If a RGB-LED could be used as a source, the color wheel is not needed anymore but the colors can be obtained just by modulating chips with different colors separately. In order to use such an RGB-LED there needs to be a means how to uniformly and efficiently couple light from the source to the fibers so that every fiber is filled with the same amount of light of each color. Embodiments of this invention can solve this problem too. FIG. 34 shows a schematic example of a fiber projector with a RGB-LED source 202 and optionally also a lightpipe 204 and/or diffuser 206 outputting to an optical engine 208 according to the teachings of the invention set forth above, but with light output from the FEI 210 being focused via a focusing lens arrangement 214 into a fiber bundle 216.

### RGB-Spot Light

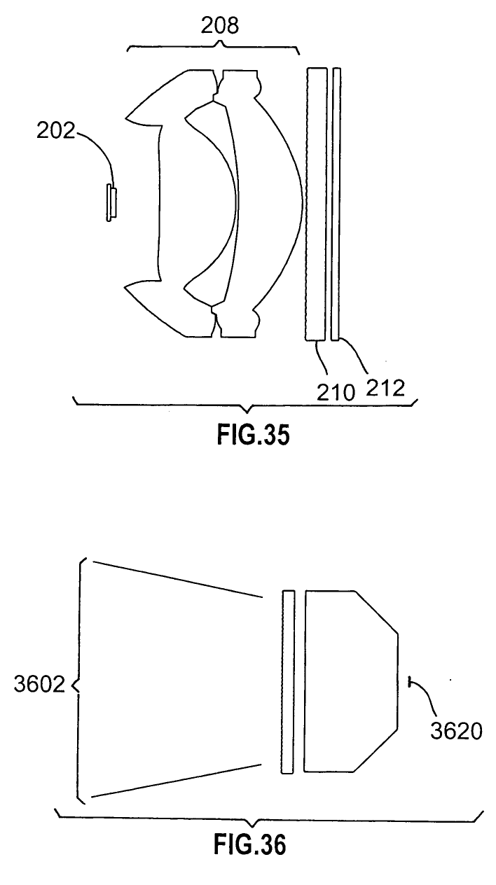

FIG. 35 shows an embodiment of the invention used as a high-efficiency RGB-spot light using RGB-LED source 202 in an arrangement similar to that shown at FIG. 2.

### Data Projector

One embodiment of the invention uses the described beam collection and homogenization system as a part of a data-projector, LED-illuminated data-projector in particular.

### Beam Opposite Direction

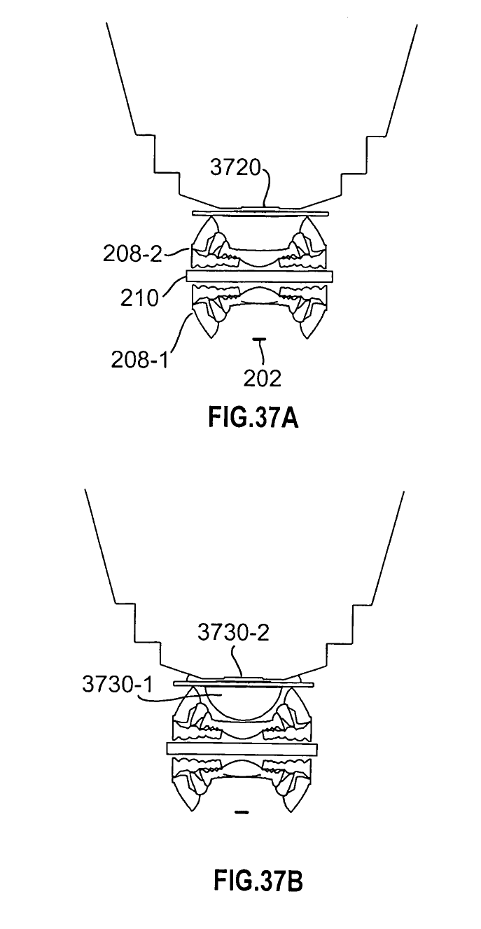

The embodiments of the current invention can be used in opposite beam direction, too. That is beneficial in applications where some object needs to be filled uniformly with light. FIG. 36 shows an exemplary system where a non-uniform light beam 3602 can be used to produce very uniform illumination to a target 3620. One very beneficial application for that is for micro-scope illumination. An embodiment of the current invention applied to a micro-scope illumination is shown in FIG. 37A comprising a white LED, or RGB-LED source 202, a first optical engine 208-1, a FEI 210, and another (second) optical engine 208-2. The uniform beam is formed to the specimen 3720 which is viewed through a micro-scope objective. The illuminator module used as the optical engine provides the possibility to use oil-immersion objective as shown in FIG. 37B. The specimen 3720 is surrounded by a hemispherical dome 3730-1 on the illumination side and by an oil immersion liquid 3730-2 from the imaging side.

Although described in the context of particular embodiments, it will be apparent to those skilled in the art that a number of modifications and various changes to these teachings may occur. Thus, while the invention has been particularly shown and described with respect to one or more embodiments thereof, it will be understood by those skilled in the art that certain modifications or changes may be made therein without departing from the scope of the invention as set forth above.

We claim:

1. An optical system comprising at least:
a source module comprising a non-uniform extended source;
at least one of a lightpipe and a lenslet array arrangement; and
an optical engine, comprising:
a first toroidal ray guide defining an axis of revolution and having a toroidal entrance pupil adapted to image radiation originating from the source module that is incident on the entrance pupil, said first toroidal ray guide having a first imaging surface opposite the entrance pupil; and
a second ray guide also defining the axis of revolution and having a second imaging surface adjacent to the first imaging surface, wherein at least one of:
the lightpipe is disposed between the source module and the optical engine,
and the optical engine is disposed between the source module and the lenslet array arrangement.

2. The optical system according to claim 1, in which the non-uniform extended source comprise multiple wavelength light sources.

3. The optical system according to claim 2, in which the multiple wavelength light sources comprise at least one red, one green, and one blue light emitting diode.

4. The optical system according to claim 1, in which the toroidal entrance pupil is adapted to image radiation incident on the entrance pupil at an angle between 40 and 140 degrees.

5. The optical system according to claim 1, in which the lenslet array arrangement comprises a first lenslet array and a second lenslet array arranged such that substantially all light incoming to each lenslet of the first lenslet array is directed to a corresponding lenslet in the second lenslet array.

6. The optical system according to claim 5, in which the first and second lenslet arrays are spaced from one another by a distance L that is close to the focal length of the lenslets multiplied by the index of refraction of an optical material disposed between the first and second lenslet arrays.

7. The optical system according to claim 5, in which at least one of the first and second lenslet arrays is moveable relative to the other of the first and second lenslet arrays in a direction of an optical axis of the lenslets.

8. The optical system according to claim 7, further comprising a fly's eye lens arrangement disposed between the optical engine and the first lenslet array.

9. The optical system according to claim 5, further comprising light blocking boundaries between the lenslets or between the first and the second lenslet array.

10. The optical system according to claim 5, in which the lenslets of the first and second arrays are oriented commonly in at least five different sections across the first and second arrays.

11. An optical system comprising at least:
a source module comprising a non-uniform extended source;
at least one of a lightpipe and a lenslet array arrangement; and
at least one ray guiding component that is substantially cylindrically symmetrical about an axis of revolution,
said at least one ray guiding component being arranged to substantially image at least a portion of the rays, which emanate from the source module towards an entrance pupil of the said at least one ray guiding component, to an image;
said at least one ray guiding component being arranged to substantially image the entrance pupil into an exit pupil of the said at least one ray guiding component, such that each point on the entrance pupil is substantially imaged to a projection of the point substantially along the direction of the said axis of revolution on the exit pupil;
said at least one ray guiding component being arranged to have substantially all points of the entrance pupil at approximately a same distance from the source module; and
said at least one ray guiding component being arranged so that no path of any meridional ray imaged from the entrance pupil into the exit pupil crosses the said axis of revolution between the entrance pupil and the exit pupil;
wherein at least one of:
the lightpipe is disposed between the source module and the at least one ray guiding component,
and the at least one ray guiding component is disposed between the source module and the lenslet array arrangement.

12. The optical system according to claim 11, in which the non-uniform extended source comprise multiple wavelength light sources.

13. The optical system according to claim 12, in which the multiple wavelength light sources comprise at least one red, one green, and one blue light emitting diode.

14. The optical system according to claim 11, in which the entrance pupil is toroidal about the axis of revolution and adapted to image radiation incident on the entrance pupil at an angle between 40 and 140 degrees.

15. The optical system according to claim 11, in which the lenslet array arrangement comprises a first lenslet array and a second lenslet array arranged such that substantially all light incoming to each lenslet of the first lenslet array is directed to a corresponding lenslet in the second lenslet array.

16. The optical system according to claim 15, in which the first and second lenslet arrays are spaced from one another by a distance L that is close to the focal length of the lenslets multiplied by the index of refraction of an optical material disposed between the first and second lenslet arrays.

17. The optical system according to claim 15, in which at least one of the first and second lenslet arrays is moveable relative to the other of the first and second lenslet arrays in a direction of an optical axis of the lenslets.

18. The optical system according to claim 17, further comprising a fly's eye lens arrangement disposed between the optical engine and the first lenslet array.

19. The optical system according to claim 15, further comprising light blocking boundaries between the lenslets or between the first and the second lenslet array.

20. The optical system according to claim 15, in which the lenslets of the first and second arrays are oriented commonly in at least five different sections across the first and second arrays.
